(19) United States
(12) Patent Application Publication
(10) Pub. No.: US 2006/0272681 A1
(43) Pub. Date: Dec. 7, 2006

(54) Water coil blow down system

(76) Inventor: Paul Scott Steinkiste, St. Louis, MO (US)

Correspondence Address: PATRICK W. RASCHE;ARMSTRONG TEASDALE LLP, ONE METROPOLITAN SQUARE, SUITE 2600, ST. LOUIS, MO, 63102-2740, US

(21) Appl. No.: 11/145,685

(22) Filed: Jun. 6, 2005

(51) Int. Cl. B08B 9/00; A23L 3/36

(52) U.S. Cl. 134/22.12; 62/303

(57) ABSTRACT

A coil blow down system includes a compressed air source and an air panel in air flow communication with the compressed air source. The air panel includes a pressure regulator and at least one ball valve. The system also includes at least one coil assembly in air flow communication with said air panel and a drain.

### BACKGROUND OF THE INVENTION

This invention relates generally to water coils, and more particularly, to methods and apparatus for draining water from coils of air handling units and makeup air units.

At least some known air handling units and makeup air units have water coils exposed to ambient air. During warm weather, the outside air is used to exchange heat in the heating cycle. However, during cold weather, such as winter, the water left in the coils can freeze and the coils can sustain damage or form leaks. At least some known air handling units include a freeze protection system coupled to the water coils for continuously circulating running water through the coils. More specifically, when temperatures drop below freezing, heated water is continuously forced into the coils. Unfortunately, revenue is lost during this process because continuously circulating water wastes energy due to the heating and recirculation of the water. Other known freeze protection systems couple heat tapes around the coils to keep the coils form freezing. However, installation and operation costs are high and the heat tapes are unreliable and unsafe.

At least some known air conditioning units include anti-clogging systems for drain lines to remove algae and contaminants. Specifically, moisture collected through a condensation process is collected in a drain pan and eventually passes through a drain line where a clog in the drain line can lead to an overflow in the drain pan. Some known anti-clogging systems force liquids or air in to the drain line. However, these systems are limited to removing clogs in low volume drain tubes and lines.

It is also known to couple valve mechanisms to drain lines for clearing blocked drain lines. More specifically, a valve mechanism includes a first T-connector joined on an upstream side and a second T-connector joined on a downstream side. When the drain line becomes blocked, the valve mechanism is closed and a pressure or vacuum source is attached to the T-connector corresponding to the portion thought to be blocked. However, the system is limited to clog removal of drain lines.

### BRIEF DESCRIPTION OF THE INVENTION

In one aspect, a coil blow down system is provided. The coil blow down system includes a compressed air source and an air panel in air flow communication with the compressed air source. The air panel includes a pressure regulator and at least one ball valve. The system also includes at least one coil assembly in air flow communication with said air panel and a drain.

In another aspect, an air panel for a coil blow down system is provided. The air panel includes an inlet valve configured to couple to a compressed air source and at least one drain valve in air flow communication with the inlet valve. The panel also includes at least one pressure regulator configured to control air flow through the air panel and at least one check valve in air flow communication with the regulator, wherein the check valve is configured to permit air flow in only one direction. The air panel further includes at least one outlet valve configured to be in air flow communication with at least one coil assembly.

In another aspect, a method forcing air into at least one water coil assembly is provided. The method includes coupling a coil blow down system including an air panel having a plurality of valves and at least one pressure regulator to the at least one water coil assembly and closing a supply valve and a return valve within the air panel. The method also includes opening a drain valve, monitoring a pressure gauge on the at least one pressure regulator for a zero pressure reading, and opening an air valve upon achieving the zero pressure reading. The method further includes regulating the pressure gauge to a predetermined amount and forcing air through the coil blow down system into the at least one water coil assembly.

### BRIEF DESCRIPTION OF THE DRAWINGS

FIG. 1 is a diagram of an exemplary embodiment of a water coil blow down system.

FIG. 2 is a diagram of an exemplary embodiment of a water coil blow down air panel.

### DETAILED DESCRIPTION OF THE INVENTION

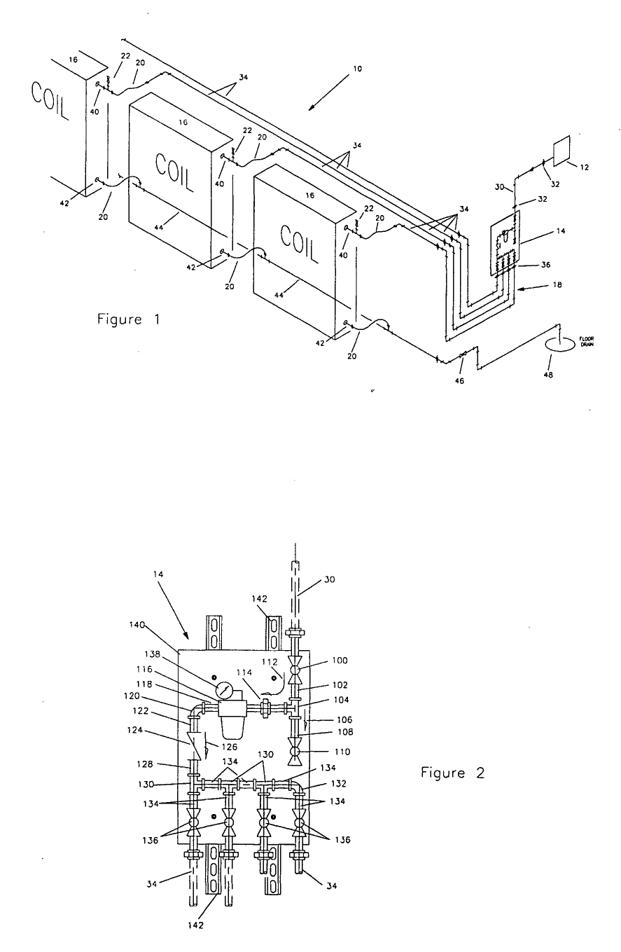

FIG. 1 is a diagram of an exemplary embodiment of a water coil blow down system 10. While system 10 is described in terms of specific embodiments, it is by no means limited to those embodiments. Details of these embodiments have been provided in order to provide a thorough understanding of coil blow down system 10. It will be apparent to one of ordinary skill in the art, however, that system 10 may be practiced without limitation to any specific details presented herein.

In the exemplary embodiment, system 10 includes coil blow down air panel 12, a compressed air source 14, and a plurality of water coil assemblies 16 coupled together by a plurality of pipes or headers 18, hoses 20, and valves 22. Components used within coil blow down system 10 may have a variety of shapes, sizes, and capacities, for example, system 10 can be used in conjunction with a plurality of components including, but not limited to, pipes, headers, hoses, valves, gauges, brackets, regulators, panels, and drains. Additionally, system 10 can be fabricated from a plurality of materials including, but not limited to, copper, brass, steel, aluminum, plastic, and wood.

Compressed air source 12 is known in the industry and may be one of a variety of shapes, sizes, and capacities sufficient to enable system 10 to function as described herein. In the exemplary embodiment, air source 12 is a conventional air compressor. Air compressor 12 is coupled to air panel 14 (discussed in greater detail below) by a supply pipe 30 and fittings 32. In the exemplary embodiment, pipe 30 is a half-inch copper pipe and fittings 32 are a mineral insulated fittings. In alternative embodiments, pipe 30 and fittings 32 may be sized and fabricated from any other suitable material that enables pipe 30 and fittings 32 to function as described herein.

In the exemplary embodiment, one air panel 14 is coupled to air compressor 12 and a plurality of water coil assemblies 16. Specifically, air panel 14 is coupled to four water coil assemblies 16. In one embodiment, a plurality of air panels 14 are coupled to a plurality of air compressors 12 and water coil assemblies 16. In another embodiment, air panel 14 is couple to one air compressor 12 and one water coil assembly 16. In yet another embodiment, a single air panel 14 is coupled to a plurality of air compressors 12 and a plurality of water coil assemblies. In an alternative embodiment, air panel 14 is coupled to, and/or between, any number of air compressors 12 and water coil assemblies that enable air panel 14 to function as describe herein.

In the exemplary embodiment, air panel 14, shown in greater detail in FIG. 2, is coupled to four pipes or blow headers 34 and fittings 36. In the exemplary embodiment, headers 34 are half-inch copper pipes and fittings 32 are socket welded fittings. In alternative embodiments, headers 34 and fittings 36 are sized and fabricated from any suitable material that enables headers 34 and fittings 36 to function as described herein.

Water coil assemblies 16 may have various shapes and sizes to facilitate heating and cooling Air Handling Units (AHUs) and/or Makeup Air Handling Units (MAUs). Water coil assemblies 16 may be found in both residential and commercial settings. Additionally, system 10 is not limited to water coil assemblies 16 coupled to AHUs/MAUs, rather system 10 is applicable to any mechanism that contains interior and/or exterior plumbing systems and/or water coil assemblies where it is desirable to remove the water to prevent damage or leakage in pipes or hoses.

In the exemplary embodiment, each water coil assembly 16 includes at least one water pipe (not shown) extending therethrough. The water pipe is configured to couple to an inlet port 40 and an outlet port 42. Inlet ports 40 are each coupled to a valve 22. In the exemplary embodiment, valve 22 is a quarter-inch vent valve. Each vent valve 22 is coupled by braided flex hose 20 to blow down header 34 such that each blow down header 34 is coupled to the corresponding water coil assembly 16. Each outlet port 42 is coupled to drain header 44 by braided flex hose 20 such that each corresponding water coil assembly 16 is coupled in series with drain header 44. In the exemplary embodiment, drain header 44 is three-fourths inch copper pipe. In alternative embodiments, drain header 44 is sized and fabricated from any suitable material that enables drain header 44 to function as described herein.

Drain header 44 is coupled to a drain valve 46 and a drain 48. In the exemplary embodiment, drain valve 46 is a three-fourths inch brass valve. In alternative embodiments, drain valve 46 is sized and fabricated from any suitable material that enables drain valve 46 to function as described herein.

FIG. 2 is a diagram of an exemplary embodiment of a water coil blow down air panel 14 including a supply or inlet valve 100 coupled to supply pipe 30. In the exemplary embodiment, supply valve 100 is a ball valve. Supply valve 100 is configured to open and close such that compressed air from air compressor 12 is supplied to air panel 14 and to coil blow down system 10. In another embodiment, valve 100 is a solenoid coupled to an automatic valve controller (not shown).

Panel 14 further includes a plurality of straight pipes and T-pipes. A straight pipe section 102 extends from valve 100 to T-pipe section 104. T-pipe section 104 branches in a first direction 106 via a straight pipe section 108 towards a drain valve 110. In the exemplary embodiment, drain valve 110 is a half-inch brass valve. In alternative embodiments, drain valve 110 is configured to open and close to remove air, fluid, and/or debris from air panel 14.

T-pipe section 104 branches in a second direction 112 towards a fitting 114 and a pressure regulator 116. Pressure regulator 116 is known in the art and is configured to regulate compressed air prior to entering coil blow down system 10. Pressure regulator 116 is coupled to straight pipe section 118 which leads to a curved section, e.g., an elbow portion, 120 and a straight pipe section 122. Section 122 is coupled to a check valve 124. In the exemplary embodiment, check valve 124 is a half-inch check valve configured to permit air flow in only one direction 126.

Check valve 124 leads to straight pipe section 128 coupled to a plurality of T-pipes 130 and an elbow section 132. A plurality of straight pipe sections 134 extend between T-pipes 130, elbow section 132, and a plurality of ball valves 136. In the exemplary embodiment, air panel 14 includes three T-pipe sections 130, one elbow pipe section 132, and four ball valves 136. In the exemplary embodiment, ball valves 136 are half-inch return ball valves. In alternative embodiments, ball valves 136 are solenoids coupled to an automatic valve controller. Each valve 136 couples with a corresponding header 34 and is configured to open and close such that compressed air is supplied to coil blow down system 10.

In the exemplary embodiment, air panel 14 is housed in a housing 140 and is mountable to a variety of surfaces by mounting brackets 142. In alternative embodiments, housing 140 and mounting brackets 142 is sized and fabricated from any suitable material that enables air panel 14 to function as described herein.

In operation, supply valve 100 and return valves 136 are closed and drain valve 46 is opened such that water present in water coil assemblies 16 drains out of drain valve 46 into drain 48. Drain valve 110 is opened until a gauge 138 on pressure regulator 166 reaches zero. Drain valve 110 is closed and supply valve 100 and return valves 136 are opened while the compressed air pressure is regulated to a predetermined amount on pressure regulator 116. In the exemplary embodiment, for the illustrated four coil assemblies pressure is set at approximately four pounds per square inch. As the compressed air enters blow down header 34, hoses 20, and coil assemblies 16, air, water, and/or debris is forced out and through header drain pipe 44, valve 46, and drain 48. Blow down operations are compete when no water exits opened valve 46.

In the exemplary embodiment, valves 44, 100, 124, and 136 are operated manually. In alternative embodiments, valves 44, 100, 124, and 136 are solenoid valves and are configured to open and close automatically at scheduled intervals or times. In an alternative embodiment, valves 44, 100, 124, and 136 open and close in a predetermined order. In alternative embodiments, solenoid valves open and close simultaneously.

Coil blow down system 10 forces air into water coil assemblies displacing and forcing water out and leaving water coil assemblies and pipes dry. Coil blow down system 10 may be configured to couple to any closed piping or tubing assembly where water and/or debris are required to be removed due to potential damage or leakage.

While the invention has been described in terms of various specific embodiments, those skilled in the art will recognize that the invention can be practiced with modification within the spirit and scope of the claims.

What is claimed is:

1. A coil blow down system comprising:
a compressed air source;
an air panel in air flow communication with said compressed air source, said air panel comprising a pressure regulator and at least one ball valve;
at least one coil assembly in air flow communication with said air panel and a drain.

2. A system in accordance with claim 1 wherein said air flow regulator comprises at least one gauge configured to regulate compressed air pressure for said compressed air source.

3. A system in accordance with claim 1 further comprising a check valve configured to direct air flow in one direction.

4. A system in accordance with claim 1 wherein said at least one ball valve includes a plurality of ball valves each in flow communication with a respective plurality of coil assemblies.

5. A system in accordance with claim 1 wherein said at least one coil assembly is a water coil assembly for at least one of an air handler unit and a makeup air unit.

6. A system in accordance with claim 1 wherein said at least one ball valve is an automated solenoid valve.

7. A system in accordance with claim 1 further comprising at least one vent valve coupled to said at least one coil assembly.

8. An air panel for a coil blow down system, said air panel comprising:
an inlet valve configured to couple to a compressed air source;
at least one drain valve in air flow communication with said inlet valve;
at least one pressure regulator configured to control air flow through said air panel;
at least one check valve in air flow communication with said regulator, said check valve configured to permit air flow in only one direction; and
at least one outlet valve configured to be in air flow communication with at least one coil assembly.

9. An air panel in accordance with claim 8 further comprising a housing and plurality of mounting brackets.

10. An air panel in accordance with claim 8 further comprising a plurality of pipes coupled such that said air panel is a closeable system.

11. An air panel in accordance with claim 8 wherein said at least one inlet valve and said at least one outlet valve are configured to open and close manually.

12. An air panel in accordance with claim 8 wherein said at least one inlet valve and said at least one outlet valve are configured to open and close automatically such that said at least one inlet valve and said at least one outlet valve open and close in a predetermined sequence.

13. An air panel in accordance with claim 12 wherein said at least one inlet valve and said at least one outlet valve are configured to open and close automatically such that said at least one inlet valve and said at least one outlet valve open and close simultaneously.

14. An air panel in accordance with claim 8 further comprising a plurality of outlet valves coupled in parallel with the compressed air source and water coil assemblies.

15. A method of forcing air into at least one water coil assembly, said method comprising:
coupling a coil blow down system including an air panel having a plurality of valves and at least one pressure regulator to the at least one water coil assembly;
closing a supply valve and a return valve within the air panel;
opening a drain valve;
monitoring a pressure gauge on the at least one pressure regulator for a zero pressure reading;
opening an air valve upon achieving the zero pressure reading;
regulating the pressure gauge to a predetermined amount; and
forcing air through the coil blow down system into the at least one water coil assembly.

16. A method in accordance with claim 15 wherein the air panel is coupled to a compressed air source.

17. A method in accordance with claim 15 wherein said monitoring a pressure gauge further comprises bleeding all air pressure from the coil blow down system.

18. A method in accordance with claim 15 wherein said opening an air valve upon achieving the zero pressure reading further comprises providing compressed air into the coil blow down system.

19. A method in accordance with claim 15 wherein said regulating the pressure gauge comprises setting a predetermined pressure amount.

20. A method in accordance with claim 15 wherein said forcing air through the coil blow down system comprises displacing water and debris in the at least one water coil assembly.
